(19) United States
(12) Patent Application Publication
(10) Pub. No.: US 2003/0182383 A1
(43) Pub. Date: Sep. 25, 2003

(54) Enterprise electronic mail filtering and notification system

(76) Inventor: Xiaopeng He, Gaithersburg, MD (US)

Correspondence Address: Richard C. Litman, LITMAN LAW OFFICES, LTD., P.O. Box 15035, Arlington, VA, 22215, US

(21) Appl. No.: 10/358,268

(22) Filed: Feb. 5, 2003

Related U.S. Application Data
(60) Provisional application No. 60/356,001, filed on Feb. 12, 2002.

(51) Int. Cl. G06F 15/16

(52) U.S. Cl. 709/206; 709/203

(57) ABSTRACT

The enterprise electronic mail filtering and notification system is a distributed World Wide Web (Internet) based data processing and transmission system whose purpose is to provide a web and network based method of locating high priority electronic mail messages and alerting the intended recipients of those messages of the existence of the messages. The system includes a web server where a user may register his e-mail address and select criteria for screening e-mails from a mailbox on the user's e-mail server. When important e-mail messages are located, the user will be notified by the most convenient means as determined by the user. This system has the capability to share its user adjustable, flexible and scalable filtering and notification functions with a plurality of networked users and can be offered as a service to off network prospects that have access to the World Wide Web (Internet).

### CROSS-REFERENCES TO RELATED APPLICATION

This application claims the benefit of U.S. Provisional Patent Application Serial No. 60/356,001, filed Feb. 12, 2002.

### BACKGROUND OF THE INVENTION

1. Field of the Invention

The present invention relates generally to electronic mail, and specifically to message reception filtering, notification systems and software as used for blocking nuisance messages, and for notifying e-mail account users immediately of the most important messages.

2. Description of the Related Art

Electronic mail or e-mail systems found their genesis in the Compatible Time Sharing System (CTSS) files created by the users of networked mainframe terminal systems in the 1960s to pass messages to each other. From that period until the 1980s electronic mail developed in the form of proprietary mainframe messaging software developed by individual computer companies, such as International Business Machines, Inc. (IBM) and Bolt, Beranek and Newman Technologies (BBN). Mainframe networks maintained by businesses, government and academic institutions were connected by public or private communications lines with access being provided by either local or remote terminals. The owners and operators of these mainframe networks would sell or lease processing “time” to businesses, governmental agencies and other entities in need of computing capabilities, without those entities having to make the capital investment in their own main frame equipment. Electronic mail protocols using Compatible Time-Sharing System (CTSS), Multics and Unix command based mail file systems were developed in order to allow the users, developers and administrators of these various proprietary networks to communicate with each other. As the operation of these proprietary networks was self-contained and the use of electronic messaging was limited to a select group of scientists, technicians and academicians, the problem of “junk” e-mail essentially did not exist.

With the development of larger and more “public” networks such as the Arpanet in the 1970s and the NSFNet (the precursor of the Internet) in the 1980s, the issue of junk or nuisance e-mail messages became more of a reality. With the virtual explosion of Internet use, applications, infrastructure and numbers of connections in the 1990s and the attendant entrepreneurial and commercial opportunities presented, the generation and sending of “junk” e-mail to the numerous network users began to be a major problem. Additionally, electronic messaging moved from the realm of the research scientist and academician to the everyday businessperson, office worker and even the elementary school student. Electronic mail network connection counts went from the thousands to the millions. More significantly, the nature of modem commercial communications changed to the extent that the timely receipt of the most important e-mail messages by their intended recipients had become essential to the functioning of modem institutions.

The growth of the Internet and the corresponding growth in its use and application have been supported by a concomitant development in support communications and distributed data processing infrastructure. The IBM and BBN mainframe computer system processors and disk drives located in a few data processing centers in the 1960s and 1970s have been replaced by distributed processors, servers and routers that combine data storage, logical processing ability and communications in multi-tiered and coordinated configurations with hardware located in thousands of locations. Furthermore, the telephone based communications infrastructure has been upgraded extensively with fiber optic and various wireless media to facilitate the timely transport and reception of electronic messages. The nature and configuration of the messages themselves have changed. In addition to the standardization of the transport protocol (i.e., Short Message Transport Protocol or SMTP), message content codes have been expanded from the standard eight bit American Standard Code for Information Interchange (ASCII) based format to expanded formats that allow the embedding and attaching of text and graphic based documents of significant sizes.

In response to this potential virtual avalanche of digital information, which has the potential to clog the recipient's reception apparatus, thus preventing important messages from getting through, various systems and methods have been devised to make use of the computing and communication power inherent in the supporting systems to both filter out low priority electronic mail messages and provide easily recognizable alert notification for high priority messages. Protective software can be imbedded in the operational layers of the mail systems' server that will scan incoming messages for certain words, phrases or images in either the text, sender's address or message attachment. Algorithms established in the protective software then decide if the message should be routed for either blocking, depositing into a “hold” file, queuing or forwarded for priority message alert notification. Priority message alert notification can be accomplished through the use of a pager broadcast, wireless or terrestrial voice message or enhanced e-mail message notification displays. One of the problems with the existing filtering and notification systems is that they operate at the level of the message receiving device (i.e., the local user's server or personal computer), thus low priority and nuisance e-mail messages are allowed to utilize valuable disk space prior to being blocked or filed. Higher priority e-mail messages may wait in queue or polling orbits at higher tier e-mail network servers while the local P.C. or server is evaluating dozens of messages. Under the best of conditions the delay in receiving the priority message may only be a few seconds, but in addition to the inefficient use of data processing resources, it is highly likely that under such a scenario a high priority message could fail to complete its transmission. A variety of devices have been proposed for improving filtering and notification for e-mail messages.

U.S. Pat. No. 6,396,513, issued May 28, 2002 to J. I. Helfman et al., describes an electronic message sorting and notification system wherein incoming mail is automatically sorted into mailboxes, based on a criteria defined by the user. In addition, the user can rank the mailboxes in order of importance and the mailboxes are presented to the user in the order of rank. The system also includes an interface which displays multiple windows to the user simultaneously, showing not only the contents of mail messages, but also other information about the user's mail, such as the ranking of the mailboxes and the criteria for triggering alarms. U.S. Pat. No. 5,944,786, issued Aug. 31, 1999 to K. Quinn, discloses an automatic e-mail notification system that notifies the user of the presence of an e-mail message when the message reaches a remote server. This remote server automatically transmits a data signal to the user's local server that in turn activates a local e-mail message notification device. The message notification device can be a voice messaging system or other device. U.S. Patent Application Publication No. 2002/0169835, published Nov. 14, 2002, discloses an Internet-based method of communicating that involves the use of a networked centralized server and database that has the ability to create and transmit notification data to various end devices upon the receipt of an e-mail message. These end devices may include websites that will in turn read hyperlinks imbedded in the notification data that can activate notification messages that can be sent via private or public networks to either fax machines, telephones or pagers.

U.S. Patent Application Publication No. 2002/0032020, published Mar. 14, 2002, teaches the use of a new or improved apparatus, systems, services and business method relating to alerting persons of information, events, etc., such as incoming e-mail messages using various end devices such as computers, PDAs, telephones, pagers, MP3s and the like. U.S. Patent Application Publication No. 2002/0133554, published Sep. 19, 2002, discloses an answering agent accessible at an e-mail destination address that reads the header information on in-coming e-mail inquiries and compares it to information contained in a database in order to identify the correct addresses for pre-set responses.

Other patents showing systems and methods for filtering and notification for e-mail messages include U.S. Patent Application Publication No. 2002/0169847, published Nov. 14, 2002 (method of providing a proxy server based service to a networked communications device); U.S. Pat. No. 6,161,130, issued Dec. 12, 2000 to E. Horvitz et al. (a technique which uses a probabilistic classifier to detect “junk” e-mail by automatically updating a classifier based on the updated training set); U.S. Pat. No. 6,185,603, issued Feb. 6, 2001 to D. Henderson et al. (a message system that uses the standard e-mail subject line to control where a message gets delivered); U.S. Pat. No. 6,237,027, issued May 22, 2001 to K. N. Namekawa (an electronic mail system message notification device using a wireless base station); U.S. Pat. No. 6,249,805, issued Jun. 19, 2001 to Fleming, III (a method and system for filtering unauthorized electronic mail messages through comparison with an authorized sender list).

None of the above inventions and patents, taken either singly or in combination, is seen to describe the instant invention as claimed. Thus an enterprise electronic mail notification system solving the aforementioned problems is desired.

### SUMMARY OF THE INVENTION

The present invention is a web server-based e-mail filtering and notification system, particularly an operational layer software set that resides on a set or sets of servers upstream of the user's firewall or local protective filtering or notification software. This software set has an e-mail notification receiver that is associated with an identifiable address on a voice network and is capable of communicating with either the ringing, tone generator or voice mail system for the generation of a notice signal or message when an e-mail message has been received on the targeted server. The software set further contains an administration module that allows for the creation of a number of system user accounts and a plurality of sets of individual subscriber notification criteria. The software set also contains a configuration and utilities module that allows for maintenance, upgrading and module set integration. The software set also contains a service subscription interface that allows a third party organization to use the e-mail filtering and notification service without having to install the software/hardware set on site.

The service subscription interface module may reside on the operational and utilities layer of the targeted web server or the user's local servers. The system also contains the operational and utilities software for the functioning of an E-mail-to-Listen server and a Text-to-Speech voice message engine that, when either applied or integrated with the targeted web server, allows users to dial in, and upon entering an access code and pre-selected informational menu, subscribers can listen to voice recordings of the text content of the e-mail messages deposited into their mailbox files. The E-mail-to-Listen server and Text-to-Speech voice message engine include configurable connections to the system database that will work over the public or private voice or data network. The system's software also utilizes a database that can contain the subscriber's account information, along with access algorithms, message notification data set, priority criteria set, message routing data set and account activity log. A Graphical User Interface (GUI) provides access to the web server(s) and its associated database that allows users and administrators to register or groom new user information, change priority information, change message notification data sets, and view activity logs.

Accordingly, it is a principal object of the invention to provide a web server-based e-mail filtering and user notification system that operates at the public or private network level.

It is another object of the invention to provide operational layer software that will monitor electronic mail messages for header information, content and attachments as the messages pass the server in the course of being transmitted to the user.

It is a further object of the invention to electronically block, file or forward e-mail messages addressed to the user at the web-server level based on a set of user selected criteria.

Still another object of the invention is to provide a variety of methods of electronic user notification when an approved priority e-mail message has been forwarded to the users message mailbox.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a high level network block diagram of an enterprise electronic mail notification system according to the present invention.

FIG. 2 is a flow chart showing the operation of the e-mail detection, filtering and monitoring system in accordance with the present invention.

FIG. 3 is a flow chart showing the operation of the notification subsystem in accordance with the present invention.

FIG. 4 is flow chart showing the operation of the universal mailbox access interface layer in accordance with the present invention.

FIG. 5 is a flow chart showing the operation of the universal notification receiver interface layer in accordance with the present invention.

FIG. 6 is a block diagram of the service subscription interface in accordance with the present invention.

FIG. 7 is a block diagram of the E-mail-to-Listen subsystem in accordance with the present invention.

Similar reference characters denote corresponding features consistently throughout the attached drawings.

### DETAILED DESCRIPTION OF THE PREFERRED EMBODIMENTS

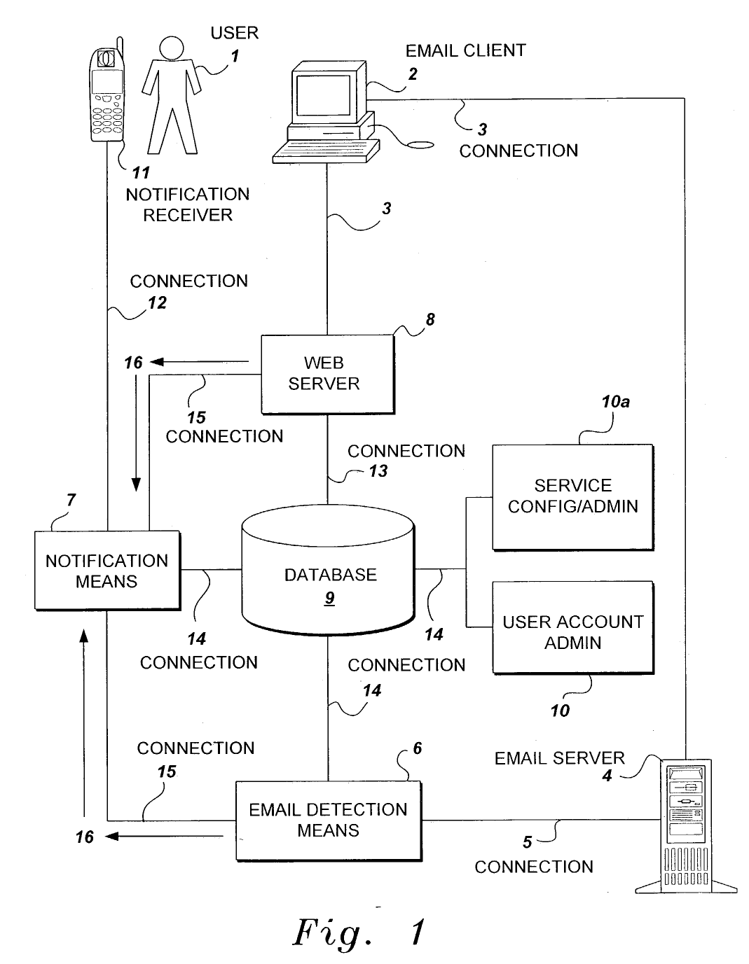

The present invention is a web-server based e-mail message filter and notification system. The system and its associated apparatus is designed to filter, file, block or forward low priority e-mail messages at the web server level and then send a notification data signal to the user via a specified notification channel to a specified end device. Referring to FIG. 1, the e-mail notification system includes a web server 8 that serves as the main user interface to the E-mail notification system. As used herein, the term web server refers to a computer connected to a network and having software stored and operating thereon for publishing web pages and forms. As conventionally known in the art, the computer has a processor, and an area of main memory comprising read only memory (ROM) and random access memory (RAM), such that software loaded into and operating in main memory is capable of publishing web pages in hypertext markup language (HTML) and receiving responses to forms using hypertext transfer protocol (HTTP). Such web server configurations are well known in the art, and will not be described further, except as required to describe the modified system of the present invention. The user 1, utilizing e-mail client software loaded on to an e-mail enabled machine 2, interacts with the Web server 8 via a public or private network connection 3. The user 1 may access a web page published by the web server 8 which provides a Graphical User Interface (GUI) to modify e-mail detection criteria settings. New users 1 can also register a new account for e-mail notification. Such work is saved into the system database 9 via the associated network connection or inter-machine data bus 13. The database may service a plurality of system web servers 8. Conversely the system's databases 9 are scalable and configured for redundancy and disaster recovery. The web server 8 also hosts in its operational layer an e-mail notification service subscription interface, discussed below, that allows third party organizations to utilize the notification service capabilities. The web server 8 can communicate directly to the notification means 7 through connection 15. System security is provided by industry standard firewalls located at appropriate interfaces.

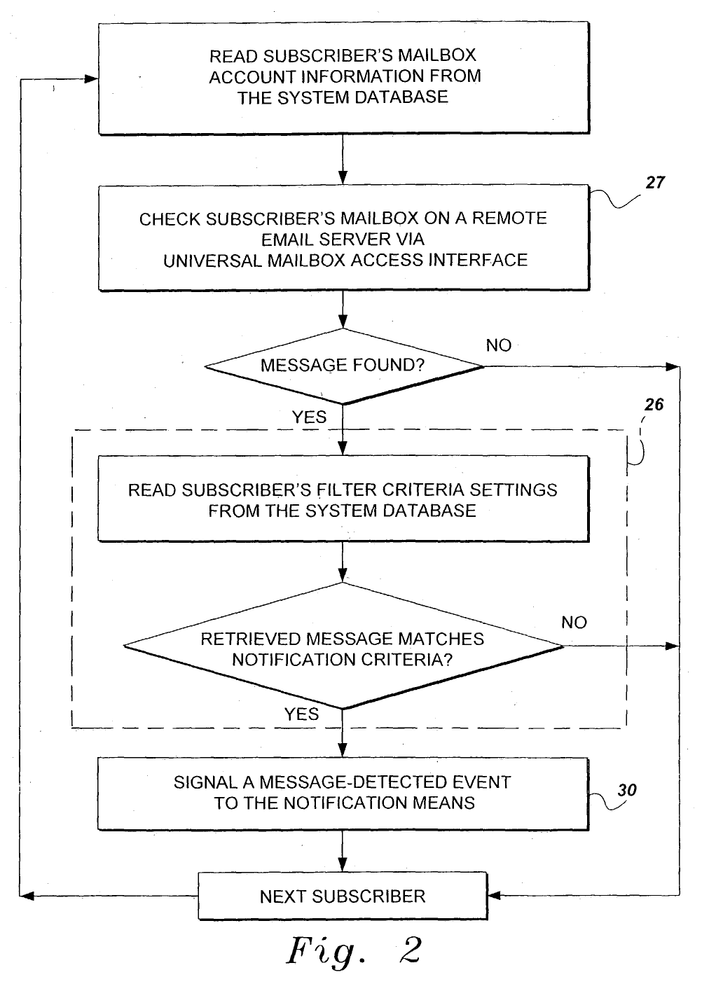

An e-mail detection traffic scanner 6 communicates with the system database 9 and the user's e-mail server 4 to check the user's mailbox for new e-mail messages. E-mail detection means 6 uses the logical loop shown in FIG. 2, discussed below, to generate a data signal. The e-mail detection means 6 is preferably modular and disconnectable from the e-mail server 4 for flexibility and scalability, although any e-mail detection means is within the scope of the present invention. The e-mail detection system 6 preferably is also capable of communicating with all industry brand e-mail servers via a universal mailbox access interface device. The user 1 is able to have his e-mail box(es) checked and filtered without having to dial-up or log onto the system from his user workspace.

The e-mail detection scanner 6 is implemented as an endless software loop running through each user's account information, as contained in the system database 9. Each user's mailbox account information includes a name, e-mail address or Internet Protocol (IP) address of the e-mail server 4, and other data. The e-mail detection scanner 6 cross references this account information with the e-mail server to check whether or not there are any messages in the user's mail box. If a message is found, it is transported via the universal mailbox access interface to the system database 9 for comparison with the user's prioritization criteria filter. If the message passes the criteria set by the user 1, a data packet is released to the notification means 7 through connection 15. Arrow 16 depicts the direction of the flow of the data packet from the e-mail detection means 6 to the notification means 7.

The e-mail notifier 7, upon receiving a released data packet from the e-mail detector 6 that an approved priority e-mail message has been received and evaluated based on the user's prioritization criteria residing in the system database 9, activates its message notification function. This notification function is expressed in the form of a short voice message, text message, audible or tactile alarm, or full text message for a facsimile machine, schematically represented as notification receiver 11 in the drawings. The notifying data packet may be transported to the notifying functional end device 11 via various transmission media as selected by the user 1, and as programmed into the system database 9.

The system contains a user account administration program 10 which manages user accounts, adds or deletes new accounts, modifies account details and log in information, changes or additions to filtering criteria and notification methods. This system also contains a service configuration and administration program 10a that manages relevant software components installed on the server computer. One of the tasks the service configuration and administration program 10a performs is to configure a new system database 9 to receive user account creation requests from the web server 8 in case the old system database 9 is full or requires shutdown maintenance. Foundation system network administration and control is discrete and separable from the operational customer servicing system, which may be deployed at the open network level (Internet). After being notified of the existence of an e-mail message in the mail box on the e-mail server 4, the user 1 can start the e-mail client software to have the message delivered to the mailbox on his workstation, not only knowing that the messages are in the mailbox on the e-mail server 4 waiting to be retrieved, but having a general idea of what kind of message to expect, because only those e-mail messages that pass the e-mail filter will generate a user notification signal packet.

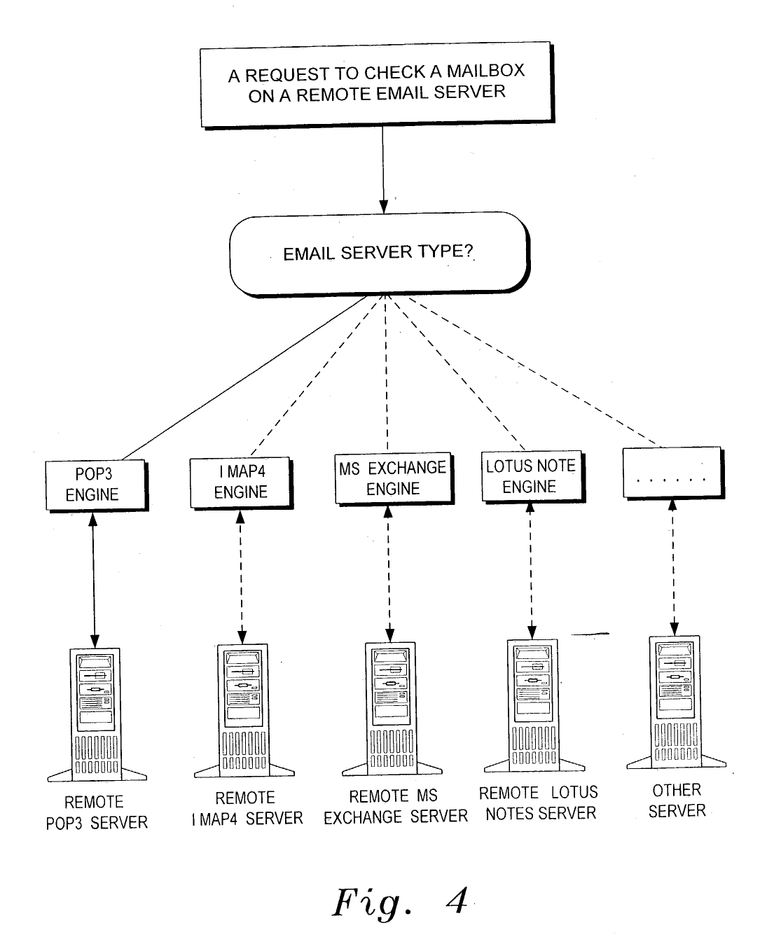

FIG. 2 further illustrates a flow chart illustrating the detailed operation of the e-mail detection means 6, and the e-mail filter 26. The detection means 6 is implemented as a software component which includes an endless loop running through each subscriber's record in a given system database 9. At the beginning of each loop, a user's mailbox account information is read from the system database 9 in order to access the subscriber's mailbox on the remote e-mail server 4. Each subscriber's mailbox account information table includes a name or IP address of the e-mail server 4, type of e-mail server 4, e-mail address of the user, and the log-in credentials (user ID and password) for accessing the subscriber's mailbox on the e-mail server 4. Using the user's mail box account information, the e-mail detection means 6 communicates with the remote e-mail server 4 to check whether or not there are any e-mail messages in the user's mailbox. This operation is accomplished by another software component, universal mailbox access interface 27 that is shown in detail in FIG. 4, discussed below. If messages are found in the user's mailbox, these messages are routed to the e-mail filter 26 to screen out lower priority messages and forward the higher priority messages to the notifier 7. High priority messages are then forwarded to a storage file for possible later access by the notifier 7.

The system provides for five types of e-mail filters: (i) message sender's e-mail addressers (senders), which allows the user 1 to obtain notification for e-mails only from a pre-approved list of addressers; (ii) a positive title text scan that filters out messages not containing certain words or phrases in their titles; (iii) a positive message body text scan that filters out messages not containing certain words or phrases in the body of the message; (iv) a positive message attachment scan that filters out messages not containing certain words or phrases in the attachments; and/or (v) priority of each message.

The filtering criteria are saved to the system's database 9 and is read by the e-mail filter 26. Depending on the user's selection, the e-mail filter 26 will look into the text content of each retrieved message and/or, if necessary, into the binary attachments of each retrieved message, to see if there is a match. In the case of encrypted messages, a user will have to provide his private key to the system database 9 so that the e-mail filter 26 can decrypt the message and accomplish the filtering.

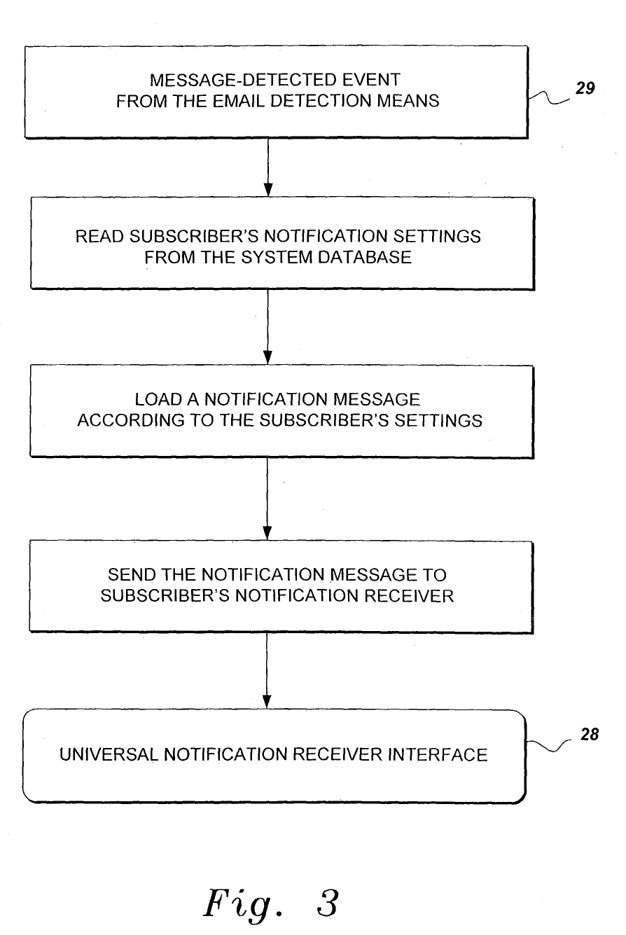

FIG. 3 is a flow chart illustrating the detailed operation of the e-mail notification means 7. The e-mail notification means 7 is implemented as a software component that is awaiting the message detected event. When the message detection event occurs, the event subscriber 29 is notified and the e-mail notification means 7 reads the user's notification from the system's database 9 and loads the appropriate notification message. This notification message may vary depending on the user's selection, and may consist of a short recorded message, a longer detailed message, an audio reproduction of the entire text message, a textual extraction from binary attachments, and/or facsimile reproductions of the message's text, all broadcast by either terrestrial or wireless media, pager broadcasts or to another e-mail address. All of these notification methods are activated by a software component called a universal notification receiver interface 28.

FIG. 4 is a diagram showing the operation of the universal mailbox access interface layer 27. The universal mailbox access interface 27 is composed of communications interfaces with various popular e-mail server communication formats, such as (Post Office Protocol, Version 3) POP3, (Internet Message Access Protocol 4) IMAP4, (Short Message Transport Protocol) SMTP, Microsoft (MS) Exchange, and Lotus Notes servers. The presence of the universal mailbox access layer 27 simplifies the client software configuration requirements when retrieving and sending e-mail messages from and to these servers.

When a request for checking an e-mailbox on a remote e-mail server comes from, for example, the e-mail detection means 6, together with information about the e-mail server, such as the name or IP address of the remote e-mail server, the e-mail interface layer 27 loads the appropriate engine, logs onto the e-mail server, checks the given mailbox for new messages, and returns any retrieved messages. A new type of mail search engine can be added to the system with very little code change at the universal access interface 27.

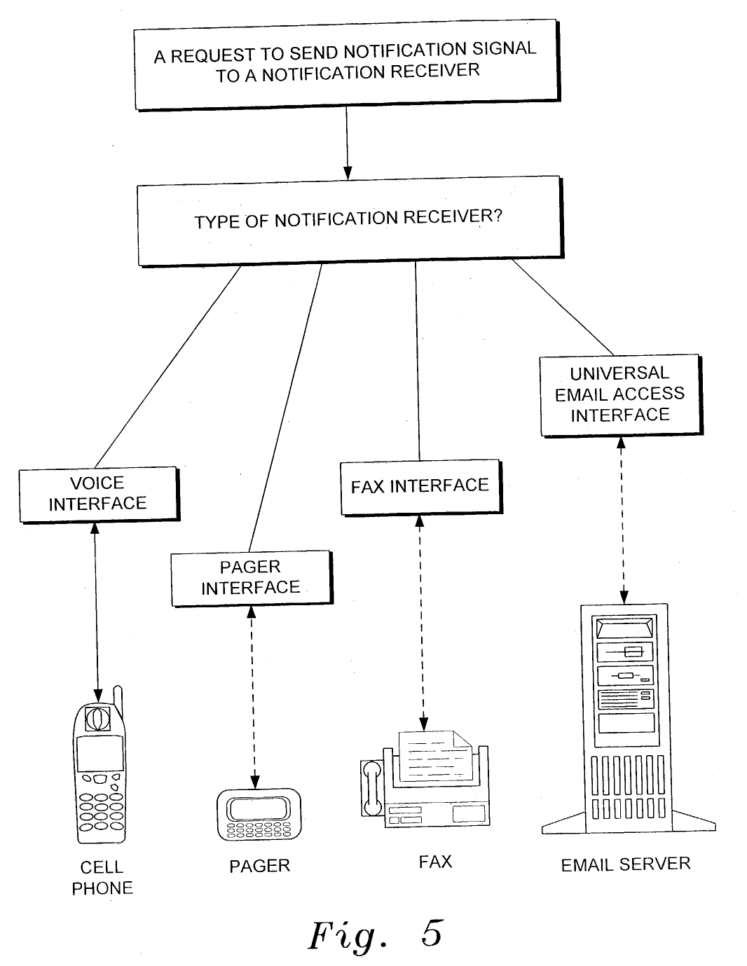

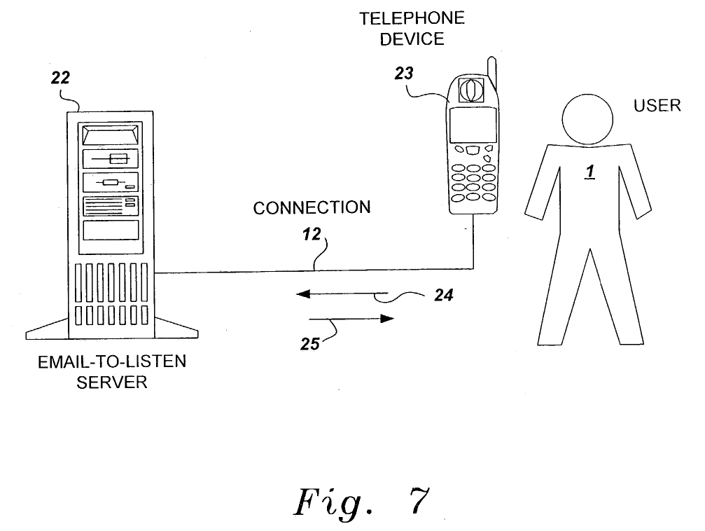

FIG. 5 is a diagram showing the operation of a universal notification interface 28. This software layer is composed of communication interfaces to various notification receiver devices 11, such as telephones, pagers, fax machines, and mail boxes that communicate with various e-mail servers. When message notification signals are sent to the various receivers via the universal notification interface 28, users are allowed to use the e-mail notification service without having to purchase a new notification device. The universal notification receiver interface 28 also simplifies the client software's system communications with various types of notification receivers. The client software of the universal notification receiver interface 28 in the present system are the e-mail notification means and the E-mail-to-Listen server 22, as shown in FIG. 7, discussed below. A notification message is sent to a notification receiver 11 as indicated by the identification of the notification receiver 11 in the request to send the notification message, the request also identifying the type of notification receiver and the textual content of the notification message. The textual content of the notification message can be a simple text as set by the user or the text content detected by the e-mail means 6. This text content can then be broadcast to the user's notification end device (i.e., pager, telephone, fax, other e-mail address).

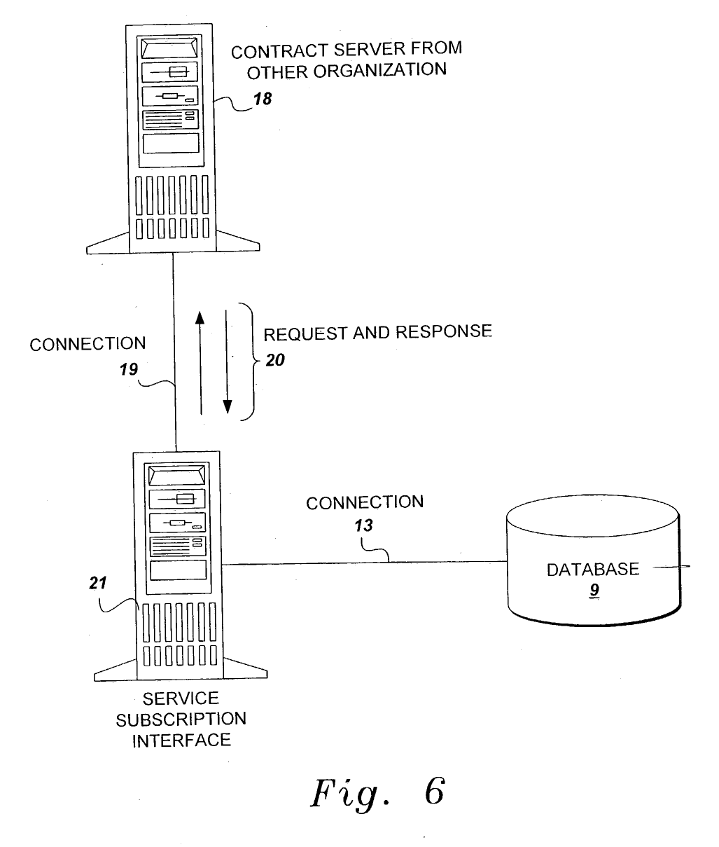

FIG. 6 is a block diagram of the service subscription interface. This interface is designed to allow other organizations to use the present e-mail notification service without installing the server and service software and hardware on site. The service subscription interface implements a Web Service that allows a contract server from another organization to make calls to functions or routines supported by the service subscription interface. As illustrated in FIG. 6, the service subscription interface 21 is installed on the web server on the public (Internet) side of the system. The service description interface 21 includes a service description file that describes the operations supported by the service description interface and software components that implement the operations. The service description file can be written in Web Service Description Language (WDSL), which is a data description format that can be understood by disparate systems over the Internet. A WDSL file defines all of the supported interactions that a web service offers in an Extended Mark-up Language (XML) format, and enumerates the data types, number and order of arguments required to carry out the interaction, as well as the data type of the returned result. The request and response 20 between the contract server 18 and the service subscription interface 21 is built upon the Simple Object Access Protocol (SOAP), a lightweight, XML-based protocol that is currently under consideration 10, by the World Wide Web Consortium (W3C) for standardization. The operations that the service subscription interface supports are implemented in a software component that can be shared either at run time level or at source code level between the web server 8 and the service description interface 21. The operations include all or part of what the web server 8 is capable of, depending on how the WDSL file is generated. The operations may also include sending a data packet to the e-mail notifier 7, allowing a third party to initiate an e-mail notification. By using the WDSL file and SOAP, third party organizations can obtain e-mail notification services.

Referring to FIG. 7, the E-mail-to-Listen server 22 allows a user 1 to dial in using a telephone device to listen to the e-mail messages delivered to his or her mailbox. The E-mail-to-Listen server 22 is connected to a system database 9 at the back end, and listens for a dial tone 24 from a telephone device 23. Upon receiving the dial tone, the E-mail-to-Listen server 22 sends a voice signal 25 to the caller asking for the telephone number to identify a valid user 1. After receiving the input of telephone number, the E-mail-to-Listen number server 22 then sends another voice signal 25 to the caller asking for a pre-approved, created or database 9 system generated security Personal Identification Number (PIN) for a security check. Three access attempts are allowed prior to a re-dial being required. When user authentication is successful, the E-mail-to-Listen server 22 will load the user's 1 mailbox account information from the system database 9, and check the user's mailbox on a remote e-mail server 4 via the universal mailbox access interface 27. If no new message is found in the user's 1 mailbox, the E-mail-to-Listen 22 server sends a voice message 25 to the caller telling him or her that the mailbox is empty at the moment and hangs up. If there are any e-mail messages found in the user's 1 mailbox, the text content of the e-mail message is converted to a voice data signal which is re-routed to the caller via the universal notification receiver interface 28. Callers are given choices to repeat the current message or go to the next message.

It is to be understood that the present invention is not limited to the embodiments described above, but encompasses any and all embodiments within the scope of the following claims.

I claim:

1. An enterprise electronic mail filtering and notification system, comprising:
(a) a web server connected to a computer network;
(b) a database connected to the web server;
(c) web page publishing means for publishing web pages and forms on the web server, the web pages and forms including:
(i) means for registering at least one user's e-mail address and e-mail account access data in the database;
(ii) means for permitting the user to select criteria for filtering e-mail received by the user's e-mail server, the criteria selected by the user being stored in the database; and
(iii) means for permitting the user to select a notification message and notification medium upon receipt of priority e-mail received by the user's e-mail server;
(d) e-mail detection means for periodically polling the at least one user's e-mail server for receipt of e-mail in an e-mail mailbox maintained for the user on the e-mail server;
(e) filtering means for scanning e-mail received in the user's e-mail mailbox using the user-selected criteria stored in the database and sorting the received e-mail for immediate notification of receipt, for storage, and for blocking; and
(f) notification means for notifying the at least one user of e-mail filtered and sorted for immediate notification of receipt.

2. The enterprise electronic mail filtering and notification system according to claim 1, wherein said at least one user comprises a plurality of users.

3. The enterprise electronic mail filtering and notification system according to claim 1, wherein said e-mail detection means further comprises universal mailbox access interface means for polling e-mail servers in a plurality of communication formats selected from the group consisting of POP3, IMAP4, SMTP, and proprietary communications formats.

4. The enterprise electronic mail filtering and notification system according to claim 1, wherein the user-selected criteria for filtering e-mail is selected from the group consisting of a sender's e-mail address, at least one word appearing in a subject matter title of an e-mail, at least one word appearing in a body of an e-mail, and at least one word appearing in the attachments of an e-mail.

5. The enterprise electronic mail filtering and notification system according to claim 1, wherein said notification means further comprises a plurality of notification devices selected from the group consisting of a telephone, a pager, a fax machine, and a second e-mail mailbox.

6. The enterprise electronic mail filtering and notification system according to claim 1, further comprising E-mail-to-Listen server means for converting a received e-mail for immediate notification from text to voice so that the user receives the received e-mail by voice.

7. The enterprise electronic mail filtering and notification system according to claim 1, further comprising service subscription interface means for permitting a contract third party to utilize at least one function performed by the electronic mail filtering and notification system without installation of said electronic mail filtering and notification system.

8. A method for filtering electronic mail and notifying a user of receipt of electronic mail, comprising the steps of:
(a) establishing a web site in a computer network;
(b) establishing a database connected to the web site;
(c) publishing a plurality of web pages and forms on the web site, including web pages and forms for registering at least one user's e-mail address and e-mail account access data in the database, for permitting the user to select criteria for filtering e-mail received by the user's e-mail server, the criteria selected by the user being stored in the database, and for permitting the user to select a notification message and notification medium upon receipt of priority e-mail received by the user's e-mail server;
(d) periodically polling the at least one user's e-mail server for receipt of e-mail in an e-mail mailbox maintained for the user on the e-mail server;
(e) scanning e-mail received in the user's e-mail mailbox using the user-selected criteria stored in the database;
(f) sorting the received e-mail for immediate notification of receipt, for storage, and for blocking; and
(g) notifying the at least one user of e-mail filtered and sorted for immediate notification of receipt.

9. The method for filtering electronic mail and notifying a user of receipt of electronic mail according to claim 8, wherein steps (c) through (g) are performed for a plurality of users.

10. The method for filtering electronic mail and notifying a user of receipt of electronic mail according to claim 8, wherein step (d) further comprises polling e-mail servers in a plurality of communication formats selected from the group consisting of POP3, IMAP4, SMTP, and proprietary communications formats.

11. The method for filtering electronic mail and notifying a user of receipt of electronic mail according to claim 8, wherein steps (e) and (f) further comprise filtering e-mail on the basis of user-selected criteria selected from the group consisting of a sender's e-mail address, at least one word appearing in a subject matter title of an e-mail, at least one word appearing in a body of an e-mail, and at least one word appearing in the attachments of an e-mail.

12. The method for filtering electronic mail and notifying a user of receipt of electronic mail according to claim 8, wherein step (g) further comprises selecting a device for notifying the user from a plurality of notification devices selected from the group consisting of a telephone, a pager, a fax machine, and a second e-mail mailbox.

13. The method for filtering electronic mail and notifying a user of receipt of electronic mail according to claim 8, further comprising the step of converting a received e-mail for immediate notification from text to voice so that the user receives the received e-mail by voice.

14. The method for filtering electronic mail and notifying a user of receipt of electronic mail according to claim 8, further comprising the step of establishing a service subscription interface on said web site for permitting a contract third party to utilize at least one function performed by the electronic mail filtering and notification system without requiring the third party to perform steps (a) through (c).

15. A computer software product that includes a medium readable by a processor, the medium having stored thereon a set of instructions for enterprise electronic mail filtering and notification, comprising:
(a) a first sequence of instructions which, when executed by the processor, causes said processor to establish a web server in a computer network;
(b) a second sequence of instructions which, when executed by the processor, causes said processor to a first sequence of instructions which, when executed by the processor, causes said processor to establish a database connected to the web server;
(c) a third sequence of instructions which, when executed by the processor, causes said processor to publish a plurality of web pages and forms on the web site, including web pages and forms for registering at least one user's e-mail address and e-mail account access data in the database, for permitting the user to select criteria for filtering e-mail received by the user's e-mail server, the criteria selected by the user being stored in the database, and for permitting the user to select a notification message and notification medium upon receipt of priority e-mail received by the user's e-mail server;
(d) a fourth sequence of instructions which, when executed by the processor, causes said processor to periodically poll the at least one user's e-mail server for receipt of e-mail in an e-mail mailbox maintained for the user on the e-mail server;
(e) a fifth sequence of instructions which, when executed by the processor, causes said processor to scan e-mail received in the user's e-mail mailbox using the user-selected criteria stored in the database;
(f) a sixth sequence of instructions which, when executed by the processor, causes said processor to sort the received e-mail for immediate notification of receipt, for storage, and for blocking; and
(g) a seventh sequence of instructions which, when executed by the processor, causes said processor to notify the at least one user of e-mail filtered and sorted for immediate notification of receipt.

16. The computer software product according to claim 15, further comprising an eighth sequence of instructions which, when executed by the processor, causes said processor to perform the third through seventh sequence of instructions for a plurality of users.

17. The computer software product according to claim 15, wherein the fourth sequence of instructions further comprises a sequence of instructions for polling e-mail servers in a plurality of communication formats selected from the group consisting of POP3, IMAP4, SMTP, and proprietary communications formats.

18. The computer software product according to claim 15, wherein the fifth and sixth sequences of instructions further comprise a sequence of instructions for filtering e-mail on the basis of user-selected criteria selected from the group consisting of a sender's e-mail address, at least one word appearing in a subject matter title of an e-mail, at least one word appearing in a body of an e-mail, and at least one word appearing in the attachments of an e-mail.

19. The computer software product according to claim 15, wherein the seventh sequence of instructions further comprises a sequence of instructions for selecting a device for notifying the user from a plurality of notification devices selected from the group consisting of a telephone, a pager, a fax machine, and a second e-mail mailbox.

20. The computer software product according to claim 15, further comprising a ninth sequence of instructions which, when executed by the processor, causes the processor to convert a received e-mail for immediate notification from text to voice so that the user receives the received e-mail by voice.

21. The computer software product according to claim 15, further comprising a tenth sequence of instructions which, when executed by the processor, causes the processor to establish a service subscription interface for permitting a contract third party to utilize at least one function of said computer software product without installation of said software product by the third party.
